(19) United States
(12) Patent Application Publication
(10) Pub. No.: US 2024/0218267 A1
(43) Pub. Date: Jul. 4, 2024

(54) AROMATICS EXTRACTION THROUGH INTEGRATION OF COMPLEMENTARY CO-SOLVENTS

(71) Applicant: UOP LLC, Des Plaines, IL (US)

(72) Inventors: Raymond Shih, Kildeer, IL (US); Souryadeep Bhattacharyya, Hoffman Estates, IL (US); Lijun Xu, Schaumburg, IL (US); Dinesh Attarde, Haryana (IN); Ankit Vishnoi, Haryana (IN)

(21) Appl. No.: 18/528,858

(22) Filed: Dec. 5, 2023

Related U.S. Application Data
(60) Provisional application No. 63/477,421, filed on Dec. 28, 2022.

(51) Int. Cl. C10G 21/22; B01D 3/40; C10G 21/16; C10G 21/20

(52) U.S. Cl. CPC C10G 21/22; B01D 3/40; C10G 21/16; C10G 21/20; C10G 2400/30

(57) ABSTRACT

Solvent mixtures for extractive distillation are described. One solvent mixture consists essentially of: a first solvent having a higher octane-to-benzene relative volatility than sulfolane in a 90% benzene 10% octane feed mixture at 150° C. and 24:1 solvent-to-feed weight ratio; a second solvent having a higher octane-to-benzene relative volatility than sulfolane in a 50% benzene 50% octane feed mixture at 150° C. and 3:1 solvent-to-feed weight ratio; and optionally an additive; wherein the solvent mixture has a higher octane-to-benzene relative volatility than Sulfolane in a combined benzene and octane feed at 125° C. and 3:1 solvent-to-feed weight ratio wherein a benzene weight ratio is higher than 30%. Another solvent mixture consists essentially of: a base solvent selected from the group consisting of sulfolane, N-methyl-pyrrolidone (NMP), N-formylmorpholine (NFM), dimethylformamide (DMF), glycol derivatives, or combinations there along with first and second co-solvents. Methods of extractive distillation are also described.

### RELATED APPLICATIONS

This application claims priority to U.S. Provisional Patent Application Ser. No. 63/477,421, filed on Dec. 28, 2022, the entirety of which is incorporated herein by reference.

### BACKGROUND

Recovery of benzene, toluene and xylene (BTX) from incoming feed streams (for example, pyrolysis gas, reformate, and the like) is central to the success of an aromatics complex. Since aromatics and non-aromatics have overlapping boiling points, solvent assisted liquid-liquid extraction (LLE) or extractive distillation (ED) is typically used in this separation. In one typical aromatics complex, the ED sulfolane extraction unit takes the feed from the reformate splitter overhead, removes the non-aromatic compounds as the raffinate stream, and sends the extract stream to one or more benzene-toluene separation column(s). Other feeds can also be used including pyrolysis gas. The name of the process comes from the sulfolane solvent used, and this solvent has remained the industry leader in BTX extraction for several decades. Enhanced separation of aromatics and non-aromatics through improvements in solvent performance could bring significant benefits to the aromatics complex and reduce overall utilities. However, improving the solvent performance is challenging because of varying process conditions within the extractive distillation column (EDC) that make evaluating the performance of a solvent a difficult task.

Therefore, there is a need for improved solvents for aromatics extraction and improved aromatics extraction processes.

### BRIEF DESCRIPTION OF THE DRAWINGS

FIG. 1 shows relative volatility (RV) of octane to benzene for several conventional solvents from COSMO-RS modeling at 125° C. and 3:1 solvent:feed weight ratio.

FIG. 2 shows the RV of octane to benzene from COSMO-RS modeling at 125° C. for various combinations of TMSO and DMSO versus sulfolane at a total solvent:feed weight ratio of 3:1.

FIG. 3 is an illustration of the processing of the COSMOtherm data.

FIG. 4 is a graph showing experimental RV for different feed compositions as a function of the benzene content in the feed mixture.

### DETAILED DESCRIPTION

Across the different stages of the EDC, the percentage of aromatics in each stage increases from the feed stage to a maximum towards the EDC bottoms. Increased aromatic content in the liquid, increased process temperatures, or increased solvent-to-feed ratios all directionally lead to single liquid phase vapor-liquid-equilibria (VLE) conditions in the ED column. There is a sharp drop in aromatic content going from the feed stage towards the top of the column, which also coincides with a sharp increase in the solvent-to-feed (S:F) ratio in the liquid phase. This complex scenario highlights the fact that any evaluation of a “better” solvent in the BTX ED process cannot be made based solely on the relative volatility (RV) of a particular composition at a particular condition, such as the feed composition at a specific condition. Aiming to maximize RV under one chosen condition, i.e. either the single liquid phase (VLE) or the two-liquid phase vapor-liquid-liquid-equilibria (VLLE) conditions, as is typically done in patents and literature, can prove detrimental to the overall ED column performance.

The development of new solvent blends for BTX extraction in the aromatics complex stems from this understanding. Single liquid phases exist in the EDC in stages below the feed stage where the percentage of aromatics is high. There is progressively decreasing aromatic content in the liquid above the feed stage, but the solvent to feed ratio also increases in conjunction. As a result, it is likely to maintain a single liquid phase above the feed stage in most cases under ED column operating guidelines. Solvents with very high single liquid phase RVs will change to the two-liquid phase (VLLE) region more easily, which leads to reduced performance especially at and above the feed stage and near the lean solvent injection stage where the percentage of aromatics is considerably lower. In general, in order to operate in the desired single liquid phase (VLE) regime by themselves, solvents with high RVs may need additional solvent to increase the S:F ratio due to their lower solubilities. The opposite is true for solvents with higher solubilities, which can prevent two phase formation in the EDC, but at the cost of reduced single liquid phase RV. This manifests itself in the bottom stages of the EDC with single liquid phase and high aromatic contents, where in order to meet product specifications, the lower selectivity requires additional solvent to increase the S:F ratio to make up for the drop in single liquid phase RV. Thus, having either a very selective solvent at the cost of solubility or a highly soluble solvent at the cost of selectivity can be detrimental to the ED process.

A variety of solvents were initially screened at 90:10 and 50:50 wt. ratio of benzene to non-aromatics at a 3:1 S:F ratio at 100° C. using COSMO-RS modeling in the COSMOTherm software as detailed in Example 1. COSMO-RS modeling implemented in the COSMOtherm software will be referred to as COSMOtherm simulation herein after. Four systems were used to evaluate the solvent systems: benzene:cyclohexane, benzene:heptane, benzene:n-octane, and benzene:ethylcyclohexane. At the 90:10 ratio, most of the solvents formed one liquid phase (i.e., the single liquid phase (VLE) case), while at the 50:50 ratio, several solvents formed two liquid phases (i.e., the two-liquid phase (VLLE) case), while others remained in a single phase. Sulfolane is an established commercial solvent which transitions to two-liquid phases (VLLE) at the 50:50 feed ratio at a 3:1 S:F ratio at about 100° C. and can be considered an industry benchmark as an aromatics extraction solvent. For the single liquid phase cases, there was a general correlation across the four systems tested, that is, a good single liquid phase solvent for one system was also good for another system. The RVs decrease with decreasing aromatic content in the feed, but they are strongly correlated for systems that stay in the single liquid phase. For strongly selective systems that transition to two liquid phases at the 50:50 condition (like sulfolane), the decrease in RV is significant. Further, there are significant challenges with mass transfer limitations when operating in the VLLE regime with reduced tray efficiencies in the distillation column.

Several solvents exhibited higher RV than sulfolane in the two-liquid phase (VLLE) region for sulfolane. These have a higher solubility of non-aromatics, along with lower polarity and lower selectivity to aromatics, and as a result can maintain the single liquid phase (VLE) for a larger range of non-aromatics in the feed at the same S:F ratio. These solvents have a lower RV in the single liquid phase (VLE region). However, their lower single liquid phase RV decreases the resulting selectivity of the solvent blend towards the feed in the single phase region where the EDC is usually designed to operate.

Some solvents exhibited a strong affinity to aromatics resulting in higher RV at higher aromatics in feed concentrations. These solvents may transition to two-liquid phases (VLLE) faster than sulfolane, and the transition significantly decreases the resulting RV. The resulting blend will show poor solubility to lean aromatic feeds and will require higher S:F ratios to maintain a single liquid phase (VLE) and to prevent severely reduced RV in two-liquid phase (VLLE) regions. These solvents cannot leverage their high RV and need more S:F than sulfolane in actual operations.

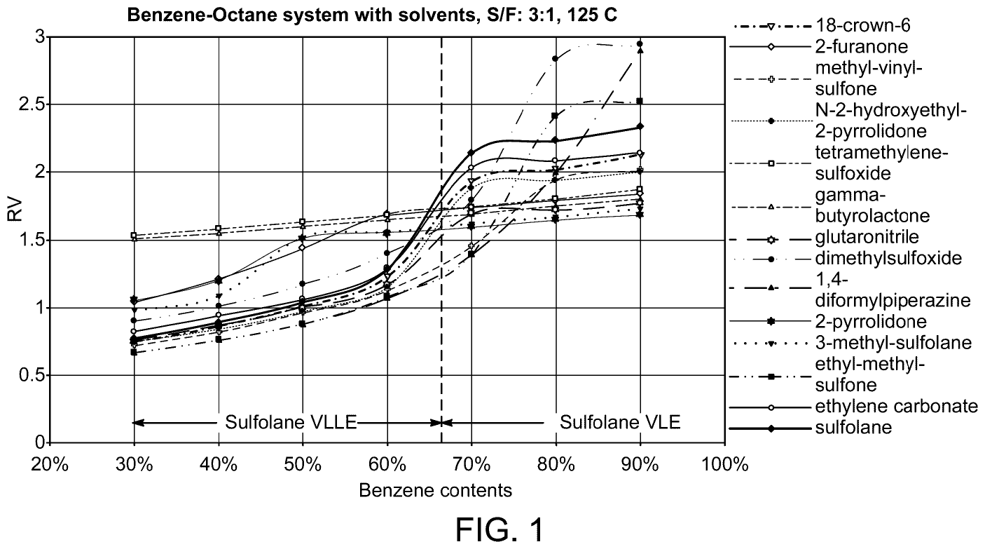

As shown in FIG. 1, none of the solvents evaluated using COSMO-RS modeling had consistently higher RV than sulfolane across the range of aromatics in the feed, i.e., better performance in the two-liquid phase region of sulfolane comes with worse performance in the single liquid phase region and vice versa. The demarcation between two liquid phases (VLLE) versus one liquid phase (VLE) for sulfolane based on the aromatics content in the feed is shown with a dashed line.

However, the present invention has shown that by combining solvents with different properties of enhanced solubility with higher aromatics selectivity, the blends have higher RV than sulfolane across the entire range of aromatics in the feed (i.e., with feed compositions that lead to either two-liquid phases or a single liquid phase for sulfolane), significantly enhancing extractive distillation solvent performance in BTX extraction.

One aspect of the invention is the solvent mixture for extractive distillation of an aromatics-containing stream. In one embodiment, the solvent mixture consists essentially of: a first solvent having a higher octane-to-benzene relative volatility than sulfolane in a 90% benzene 10% octane feed mixture at 150° C. and 24:1 solvent-to-feed weight ratio per COSMOTherm simulations; a second solvent having a higher octane-to-benzene relative volatility than sulfolane in a 50% benzene 50% octane feed mixture at 150° C. and 3:1 solvent-to-feed weight ratio per COSMOTherm simulations; and optionally an additive; wherein the solvent mixture has a higher octane-to-benzene relative volatility than Sulfolane in a combined benzene and octane feed at 125° C. and 3:1 solvent-to-feed weight ratio per COSMOTherm simulations, wherein a benzene weight ratio is higher than 30%.

Suitable first solvents include, but are not limited to, dimethylsulfoxide (DMSO), 1,4-diformyl piperazine (DFP), dimethyl sulfone (DMS), ethyl-methyl sulfone (EMS), or combinations thereof.

Suitable second solvents include, but are not limited to, tetramethylene sulfoxide (TMSO), gamma butyrolactone (GBL), 2-furanone, N-formyl morpholine (NFM), delta valerolactone (DVL), N-methyl-pyrrolidone (NMP), propylene carbonate, diethyl sulfone (DES), 3-methyl sulfolane (3-MS), or combinations thereof.

There can be one or more first solvents in the solvent mixture. For example, the first solvent could be a single solvent, or it could be a blend of two, three, four, or five of the first solvents listed. There can be one or more second solvents in the solvent mixture. For example, the second solvent could be a single solvent, or it could be a blend of two, three, four, five, six, seven, eight, or nine of the second solvents listed.

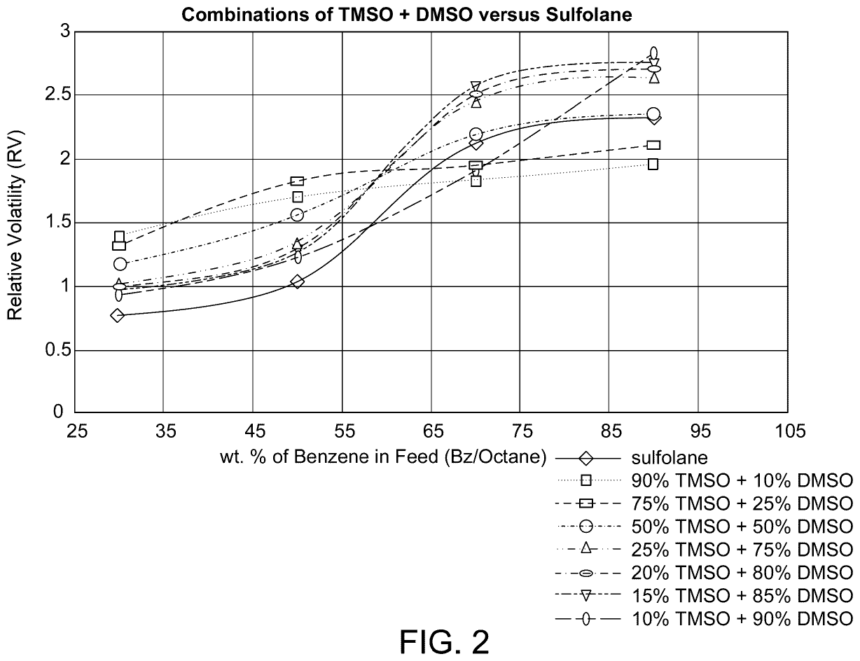

The amount of the first solvent and the second solvent present in the solvent mixture varies depending on the particular solvents used. Typically, the first solvent is present in an amount of 25% to 95% and the second solvent is present in an amount of 5% to 75%. Solvent ranges for particular solvent combinations are given below in Table 1, and an example with TMSO and DMSO solvents is demonstrated in Example 1 and FIG. 2.

The solvent mixture may contain one or more additives typically used in extractive distillation. Typical additives are known to those of skill in the art. Suitable additives include, but are not limited to, solutizers, anti-forming agents, anti-corrosion agents, stabilizers, surfactants, free-radical inhibitors, or combinations thereof.

TABLE 1

| Solvent Systems | | | |
|---|---|---|---|
| First Solvent | Second Solvent | % Second Solvent | % First solvent |
| DMSO | TMSO | 10-60 | 40-90 |
| DMS | TMSO | 55-70 | 30-45 |
| DFP | TMSO | 25-50 | 50-75 |
| EMS | TMSO | 15-50 | 50-85 |
| DMSO | GBL | 15-75 | 25-85 |
| DMS | GBL | 45-65 | 35-55 |
| DFP | GBL | 25-40 | 60-75 |
| EMS | GBL | 10-30 | 70-90 |
| DMSO | Furanone | 10-50 | 50-90 |
| DMS | Furanone | 50-70 | 30-50 |
| DFP | Furanone | 25-50 | 50-75 |
| DMSO | DES | 25-75 | 25-75 |
| DMS | DES | 50-70 | 30-50 |
| DMSO | DVL | 10-50 | 50-90 |
| EMS | DVL | 10-25 | 75-90 |
| DFP | DVL | 20-50 | 50-80 |
| DMS | DVL | 35-75 | 25-65 |
| DMSO | NFM | 15-75 | 25-85 |
| EMS | NFM | 20-50 | 50-80 |
| DMSO | 3-MS | 20-50 | 50-80 |
| DMSO | NMP | 5-40 | 60-95 |
| DMS | NMP | 30-50 | 50-70 |
| DFP | NMP | 10-25 | 75-90 |
| EMS | NMP | 10-25 | 75-90 |

Another aspect of the invention is a solvent mixture for extractive distillation of an aromatics-containing stream. In one embodiment, the solvent mixture consists essentially of: a base solvent selected from the group consisting of sulfolane, N-methyl-pyrrolidone (NMP), N-formylmorpholine (NFM), dimethylformamide (DMF), glycol derivatives, or combinations there; a first co-solvent having a higher octane-to-benzene relative volatility than sulfolane in a 90% benzene 10% octane feed mixture at 150° C. and 24:1 solvent-to-feed weight ratio per COSMOTherm simulations; a second co-solvent having a higher octane-to-benzene relative volatility than sulfolane in a 50% benzene 50% octane feed mixture at 150° C. and 3:1 solvent-to-feed weight ratio per COSMOTherm simulations; optionally an additive; wherein the solvent mixture has a higher octane-to-benzene relative volatility than the base solvent in a combined benzene and octane feed at 125° C. and 3:1 solvent-to-feed weight ratio per COSMOTherm simulations where a benzene weight ratio is higher than 30%. Suitable glycol derivatives include branched or straight saturated or unsaturated alkyl chain glycols but are not limited to ethylene glycol, triethylene glycol, and tetraethylene glycol.

Suitable first co-solvents include, but are not limited to, dimethylsulfoxide (DMSO), 1,4-diformyl piperazine (DFP), dimethyl sulfone (DMS), ethyl-methyl sulfone (EMS), or combinations thereof.

Suitable second co-solvents include, but are not limited to, tetramethylene sulfoxide (TMSO), gamma butyrolactone (GBL), 2-furanone (furan), N-formyl morpholine (NFM), delta valerolactone (DVL), N-methyl-pyrrolidone (NMP), propylene carbonate, diethyl sulfone (DES), 3-methyl sulfolane (3-MS), or combinations thereof.

There can be one or more base solvents in the solvent mixture. For example, the base solvent could be a single base solvent, or it could be a blend of two, three, four, or five of the base solvents listed. There can be one or more first co-solvents in the solvent mixture. For example, the first co-solvent could be a single co-solvent, or it could be a blend of two, three, four, or five of the first co-solvents listed. There can be one or more second co-solvents in the solvent mixture. For example, the second co-solvent could be a single co-solvent, or it could be a blend of two, three, four, five, six, seven, eight, or nine of the second co-solvents listed.

The amount of the first co-solvent and the second co-solvent present in the solvent mixture varies depending on the particular solvents used. The weight ratio of the second co-solvent to the first co-solvent may be in a range of 0.05:1 to 5:1 depending on the constituents, but is typically between 0.1:1 to 2:1, with the balance being the base solvent. The co-solvent weight ratios for particular co-solvent combinations are given below in Table 2.

The solvent mixture may contain one or more additives typically used in extractive distillation. Typical additives are known to those of skill in the art. Suitable additives include, but are not limited to, solutizers, anti-forming agents, anti-corrosion agents, stabilizers, surfactants, free-radical inhibitors, or combinations thereof.

TABLE 2

| System Co-solvents | | |
|---|---|---|
| (Balance Sulfolane) | | |
| First | Second | Second Co-solvent to First |
| Co-solvent | Co-solvent | Co-solvent Weight Ratio |
| DMSO | TMSO | 0.1:1-2:1 |
| DMS | -TMSO | 1:1-3:1 |
| DFP | -TMSO | 0.1:1-1.5:1 |
| EMS | -TMSO | 0.1:1-1.5:1 |
| DMSO | GBL | 0.1:1-5:1 |
| DMS | GBL | 0.5:1-2.5:1 |
| DFP | GBL | 0.1:1-1:1 |
| EMS | GBL | 0.1:1-1:1 |
| DMSO | Furanone | 0.1:1-2:1 |
| DMS | Furanone | 0.5:1-2.5:1 |
| DFP | Furanone | 0.1:1-1.5:1 |
| DMSO | DES | 0.1:1-5:1 |
| DMS | DES | 0.5:1-3:1 |
| DMSO | DVL | 0.1:1-1.5:1 |
| EMS | DVL | 0.1:1-1:1 |
| DFP | DVL | 0.1:1-1.5:1 |
| DMS | DVL | 0.1:1-5:1 |
| DMSO | NFM | 0.1:1-5:1 |
| EMS | NFM | 0.1:1-1.5:1 |
| DMSO | 3-MS | 0.1:1-1.5:1 |
| DMSO | NMP | 0.05:1-1:1 |
| DMS | NMP | 0.1:1-1.5:1 |
| DFP | NMP | 0.1:1-1:1 |
| EMS | NMP | 0.1:1-1:1 |

Another aspect of the invention is a method of aromatics extraction. In one embodiment, the method comprises: introducing an aromatics-containing feed stream to an extractive distillation column at a feed stage; introducing a solvent mixture to the extractive distillation column at a stage above the feed stage, the solvent mixture consisting essentially of: a first solvent having a higher octane-to-benzene relative volatility than sulfolane in a 90% benzene 10% octane feed mixture at 150° C. and 24:1 solvent-to-feed weight ratio per COSMOTherm simulations; a second solvent having higher octane-to-benzene relative volatility than sulfolane in a 50% benzene 50% octane feed mixture at 150° C. and 3:1 solvent-to-feed weight ratio per COSMOTherm simulations; and optionally an additive; recovering a bottoms stream comprising an aromatics-rich stream; and recovering an overhead stream comprising an aromatics-lean stream.

The solvent mixture can be added at a single point above the feed stage, or at multiple points above the feed stage, i.e., at two, three, four etc. points above the feed stage.

The first and second solvents, the amounts of each, and the additives are as discussed above.

Another aspect of the invention is a method of aromatics extraction. In one embodiment, the method comprises: introducing an aromatics-containing feed stream to an extractive distillation column at a feed stage; introducing a solvent mixture to the extractive distillation column above the feed stage, the solvent mixture consisting essentially of: a base solvent selected from the group consisting of sulfolane, N-methyl-pyrrolidone (NMP), N-formylmorpholine (NFM), dimethylformaide (DMF), glycol, glycol derivatives, or combinations thereof; a first co-solvent having a higher octane-to-benzene relative volatility than sulfolane in a 90% benzene 10% octane feed mixture at 150° C. and 24:1 solvent-to-feed weight ratio per COSMOTherm simulations; a second co-solvent a having higher octane-to-benzene relative volatility than sulfolane in a 50% benzene 50% octane feed mixture at 150° C. and 3:1 solvent-to-feed weight ratio per COSMOTherm simulations; and optionally an additive; recovering a bottoms stream comprising an aromatics-rich stream; and recovering an overhead stream comprising an aromatics-lean stream.

The solvent mixture can be added at a single point above the feed stage, or at multiple points above the feed stage, i.e., at two, three, four etc. points above the feed stage.

The base solvent, first and second co-solvents, the amounts of each, and the additives are as discussed above.

### EXAMPLES

COSMO-RS modeling (Klamt, A. J. Phys. Chem. 99, 2224 (1995); Klamt, A.; Jonas, V.; Bürger, T.; Lohrenz, J. C. J. Phys. Chem. A 102, 5074 (1998); Eckert, F. and A. Klamt, AIChE Journal, 48, 369 (2002)) was carried out in the COSMOtherm program (COSMOtherm (software) available from BIOVIA COSMOtherm, Release 2022; Dassault Systèmes. http://www.3ds.com.). All the molecules were chosen from the COSMOtherm database if they are available in the database or built from scratch in which the conformers of cach molecule were explored first with rational design and simple molecular dynamics simulation and simple molecular dynamics simulation implemented in the MedeA software (MedeA 3.3; MedeA is a registered trademark of Materials Design, Inc., San Diego, USA.) and followed by optimizations in the Gaussian package (Gaussian 09, Revision E.01, Frisch, M. J.; Trucks, G. W.; Schlegel, H. B. et al., Gaussian, Inc., Wallingford CT, 2013.) (DFT calculations with the B3LYP density functional and the 6-31g basis set). The most stable conformers for cach target molecule were selected with an energy cutoff at 5% or less in population relative to the most stable conformer, and then re-optimized in the TMoleX software (TURBOMOLE V7.5 2020, a development of University of Karlsruhe and Forschungszentrum Karlsruhe GmbH, 1989-2007, TURBOMOLE GmbH, since 2007; available from https://www.turbomole.org) (DFT calculations with the BP density functional, the def2-TZVPD basis set, the energy change at 10⁻⁶ Hartree or less, and the geometry energy gradient at 10⁻³ atomic units or less) before their “.cosmo” files were loaded into the COSMOtherm database. All the COSMOtherm calculations were implemented at the TVZPD-FINE accuracy level, with all the available conformers selected for each molecule. The liquid extraction was calculated in the COSMOtherm by enforcing a liquid-liquid equilibrium (LLE) between two phases with a convergence threshold of 10⁻⁵. The vapor-liquid equilibrium (VLE) was calculated with the liquid phase composition determined from the liquid extraction calculation.

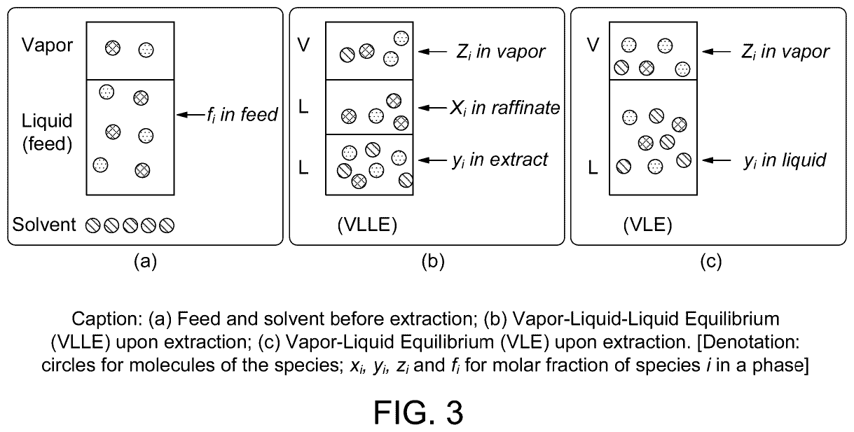

All the COSMOtherm data were processed as indicated in FIG. 3, where “extract” in the second solvent is the phase dominated by solvent, always enriched with the target solute for a selective extraction and then “raffinate” is the leftover in the original feed. Selectivity reflects relative enrichment of one species “i” against another species “k”.

For a liquid-liquid distribution (or LLE in the second solvent), the distribution coefficient Dᵢ=yᵢ/xᵢ, and the selectivity S(i/k)=Dᵢ/Dₖ.

For a vapor-liquid distribution in first or second solvent, the distribution coefficient Dᵢ=zᵢ/yᵢ and the selectivity RV(i/k)=Dᵢ/Dₖ, with species “i” usually being more volatile and for small vapor volume which is the default assumption, “yᵢ” is replaced with “fᵢ” for better comparison with experiments.

### Example 1

Tables 3A-D show the modeling results for the combinations of TMSO (second solvent) with DMSO (3A), DMS (3B), DFP (3C), and EMS (3D) (first solvents). The modeling looked at ratios of benzene to octane in the feed stream of 30:70, 50:50, 70:30, and 90:10. The ratio of TMSO to the first solvents was varied from 90:10 to 10:90 as shown. Combinations which performed better than sulfolane across the range of benzene to octane from 30:70 to 90:10 are shown italicized with an asterisk.

Table 3A-D. Combinations of TMSO with first solvents. Solvents with asterisk indicates the solvent combination performed better than Sulfolane. The data in Table 3C (combinations of TMSO with DMSO) is visually represented in FIG. 2. While neither TMSO nor DMSO alone outperform sulfolane in RV across the entire range of interest of benzene to octane in the feed, FIG. 2 highlights combinations of these two solvents several of which perform advantageously with respect to sulfolane across the entire range of interest. Direct experimental validation of this system is provided later in Example 2.

TABLE 3A

| | BZ:OCT | BZ:OCT | BZ:OCT | BZ:OCT |
|---|---|---|---|---|
| Solvent (125 C.) | (30:70) | (50:50) | (70:30) | (90:10) |
| Tetramethylene Sulfox- | 1.53 | 1.63 | 1.74 | 1.87 |
| ide (TMSO) | | | | |
| ethyl-methyl-sulfone | 0.67 | 0.88 | 1.39 | 2.52 |
| (EMS) | | | | |
| Sulfolane | 0.77 | 1.04 | 2.14 | 2.33 |
| 90% TMSO + 10% EMS | 1.35 | 1.68 | 1.80 | 1.93 |
| 75% TMSO + 25% EMS | 1.24 | 1.76 | 1.88 | 2.02 |
| 50% TMSO + 50% EMS | 1.03 | 1.36 | 2.01 | 2.17 |
| 25% TMSO + 75% | 0.83 | 1.11 | 2.15 | 2.33 |
| EMS* | | | | |
| 20% TMSO + 80% | 0.79 | 1.07 | 2.18 | 2.36 |
| EMS* | | | | |
| 15% TMSO + 85% EMS | 0.76 | 1.03 | 1.56 | 2.40 |
| 10% TMSO + 90% EMS | 0.73 | 0.98 | 1.48 | 2.44 |

TABLE 3B

| | BZ:OCT | BZ:OCT | BZ:OCT | BZ:OCT |
|---|---|---|---|---|
| Solvent (125 C.) | (30:70) | (50:50) | (70:30) | (90:10) |
| Tetramethylene Sulfox- | 1.53 | 1.63 | 1.74 | 1.87 |
| ide (TMSO) | | | | |
| 14diformyl-piperazine | 0.67 | 0.88 | 1.39 | 2.9 |
| (DFP) | | | | |
| Sulfolane | 0.77 | 1.04 | 2.14 | 2.33 |
| 90% TMSO + 10% DFP | 1.36 | 1.68 | 1.80 | 1.93 |
| 75% TMSO + 25% DFP | 1.22 | 1.75 | 1.89 | 2.04 |
| 50% TMSO + 50% DFP | 1.02 | 1.37 | 2.07 | 2.26 |
| 40% TMSO + 60% | 0.94 | 1.27 | 2.15 | 2.36 |
| DFP* | | | | |
| 35% TMSO + 65% | 0.90 | 1.22 | 2.19 | 2.41 |
| DFP* | | | | |
| 30% TMSO + 70% | 0.86 | 1.17 | 2.24 | 2.47 |
| DFP* | | | | |
| 25% TMSO + 75% DFP | 0.83 | 1.12 | 1.79 | 2.54 |

TABLE 3C

| | BZ:OCT | BZ:OCT | BZ:OCT | BZ:OCT |
|---|---|---|---|---|
| Solvent (125 C.) | (30:70) | (50:50) | (70:30) | (90:10) |
| Tetramethylene Sulfox- | 1.53 | 1.63 | 1.74 | 1.87 |
| ide (TMSO) | | | | |
| Dimethylsulfoxide | 0.9 | 1.17 | 1.79 | 2.94 |
| (DMSO) | | | | |
| Sulfolane | 0.77 | 1.04 | 2.14 | 2.33 |
| 90% TMSO + 10% | 1.39 | 1.71 | 1.83 | 1.96 |
| DMSO | | | | |
| 75% TMSO + 25% | 1.32 | 1.83 | 1.96 | 2.11 |
| DMSO | | | | |
| 50% TMSO + 50% | 1.18 | 1.56 | 2.20 | 2.37 |
| DMSO* | | | | |
| 25% TMSO + 75% | 1.02 | 1.35 | 2.46 | 2.65 |
| DMSO* | | | | |
| 20% TMSO + 80% | 0.99 | 1.29 | 2.51 | 2.71 |
| DMSO* | | | | |
| 15% TMSO + 85% | 0.97 | 1.26 | 2.57 | 2.77 |
| DMSO* | | | | |
| 10% TMSO + 90% | 0.94 | 1.23 | 1.91 | 2.83 |
| DMSO | | | | |

TABLE 3D

| | BZ:OCT | BZ:OCT | BZ:OCT | BZ:OCT |
|---|---|---|---|---|
| Solvent (125 C.) | (30:70) | (50:50) | (70:30) | (90:10) |
| Tetramethylene Sulfox- | 1.53 | 1.63 | 1.74 | 1.87 |
| ide (TMSO) | | | | |
| Dimethyl Sulfone (DMS) | 0.45 | 0.53 | 0.74 | 1.65 |
| Sulfolane | 0.77 | 1.04 | 2.14 | 2.33 |
| 90% TMSO + 10% DMS | 1.33 | 1.73 | 1.85 | 1.99 |
| 60% TMSO + 40% | 1.01 | 1.34 | 2.21 | 2.38 |
| DMS* | | | | |
| 65% TMSO + 35% | 1.08 | 1.39 | 2.14 | 2.31 |
| DMS* | | | | |
| 70% TMSO + 30% | 0.83 | 1.11 | 2.15 | 2.33 |
| DMS* | | | | |
| 75% TMSO + 25% | 0.79 | 1.07 | 2.18 | 2.36 |
| DMS* | | | | |
| 50% TMSO + 50% DMS | 0.76 | 1.03 | 1.56 | 2.40 |
| 25% TMSO + 75% DMS | 0.73 | 0.98 | 1.48 | 2.44 |

Similar modeling was performed for other second solvents with these first solvents. This modeling resulted in the combinations and blend ratios shown in Table 1 above.

### Example 2

In order to investigate the effect of two complementary co-solvents on sulfolane's performance, the amount of sulfolane in the blends was fixed at 50% and 80% in the following example. Each of Tables 4-7 shows the optimum weight ratios of various components giving comparable or improved RV over sulfolane in a combined benzene and octane feed at 125° C. and 3:1 solvent-to-feed weight ratio per COSMOTherm simulations, wherein a benzene weight ratio is higher than 30% keeping the same single first co-solvent while varying the second co-solvent and sulfolane amounts. Table 4 shows the modeling results where the first co-solvent is DMSO. In Table 5, the first co-solvent is DMS. In Table 6, the first co-solvent is DFP. The first co-solvent in Table 7 is EMS.

TABLE 4

| | BZ:OCT | BZ:OCT | BZ:OCT | BZ:OCT |
|---|---|---|---|---|
| Solvent (AT 125 C.) | (30:70) | (50:50) | (70:30) | (90:10) |
| Sulfolane | 0.77 | 1.04 | 2.14 | 2.33 |
| 50% Sulfolane + 5% | 0.87 | 1.18 | 2.41 | 2.62 |
| TMSO + 45% DMSO | | | | |
| 80% Sulfolane + 3% | 0.82 | 1.11 | 2.24 | 2.44 |
| TMSO + 17% DMSO | | | | |
| 50% Sulfolane + 5% | 0.87 | 1.17 | 2.41 | 2.61 |
| GBL + 45% DMSO | | | | |
| 80% Sulfolane + 2% | 0.82 | 1.11 | 2.25 | 2.45 |
| GBL + 18% DMSO | | | | |
| 50% Sulfolane + 5% | 0.85 | 1.16 | 2.4 | 2.61 |
| furan + 45% DMSO | | | | |
| 80% Sulfolane + 3% | 0.81 | 1.1 | 2.24 | 2.44 |
| furan + 17% DMSO | | | | |
| 50% Sulfolane + 10% | 0.85 | 1.15 | 2.36 | 2.57 |
| DES + 40% DMSO | | | | |
| 80% Sulfolane + 5% | 0.81 | 1.09 | 2.22 | 2.42 |
| DES + 15% DMSO | | | | |
| 50% Sulfolane + 5% | 0.85 | 1.16 | 2.40 | 2.61 |
| 3-MS + 45% DMSO | | | | |
| 80% Sulfolane + 3% | 0.81 | 1.10 | 2.24 | 2.44 |
| 3-MS + 17% DMSO | | | | |
| 50% Sulfolane + 5% | 0.86 | 1.17 | 2.41 | 2.62 |
| NFM + 45% DMSO | | | | |
| 80% Sulfolane + 3% | 0.82 | 1.11 | 2.24 | 2.44 |
| NFM + 17% DMSO | | | | |
| 50% Sulfolane + 5% | 0.9 | 1.2 | 2.36 | 2.56 |
| NMP + 45% DMSO | | | | |
| 80% Sulfolane + 3% | 0.84 | 1.13 | 2.21 | 2.41 |
| NMP + 17% DMSO | | | | |
| 50% Sulfolane + 5% | 0.88 | 1.18 | 2.39 | 2.60 |
| DVL + 45% DMSO | | | | |
| 80% Sulfolane + 3% | 0.83 | 1.12 | 2.23 | 2.43 |
| DVL + 17% DMSO | | | | |

TABLE 5

| | BZ:OCT | BZ:OCT | BZ:OCT | BZ:OCT |
|---|---|---|---|---|
| Solvent (AT 125 C.) | (30:70) | (50:50) | (70:30) | (90:10) |
| Sulfolane | 0.77 | 1.04 | 2.14 | 2.33 |
| 50% Sulfolane + 20% | 0.77 | 1.03 | 2.29 | 2.48 |
| GBL + 30% DMS | | | | |
| 80% Sulfolane + 10% | 0.79 | 1.07 | 2.17 | 2.36 |
| GBL + 10% DMS | | | | |
| 50% Sulfolane + 25% | 0.83 | 1.12 | 2.24 | 2.43 |
| TMSO + 25% DMS | | | | |
| 80% Sulfolane + 10% | 0.8 | 1.07 | 2.18 | 2.37 |
| TMSO + 10% DMS | | | | |
| 50% Sulfolane + 20% | 0.80 | 1.08 | 2.23 | 2.42 |
| DVL + 30% DMS | | | | |
| 80% Sulfolane + 10% | 0.81 | 1.09 | 2.14 | 2.33 |
| DVL + 10% DMS | | | | |
| 50% Sulfolane + 30% | 0.77 | 1.03 | 2.12 | 2.3 |
| 3-MS + 20% DMS | | | | |
| 80% Sulfolane + 10% | 0.76 | 1.02 | 2.16 | 2.35 |
| 3-MS + 10% DMS | | | | |
| 50% Sulfolane + 20% | 0.88 | 1.14 | 2.12 | 2.29 |
| NMP + 30% DMS | | | | |
| 80% Sulfolane + 10% | 0.85 | 1.12 | 2.09 | 2.26 |
| NMP + 10% DMS | | | | |
| 50% Sulfolane + 30% | 0.78 | 1.04 | 2.16 | 2.33 |
| furan + 20% DMS | | | | |
| 80% Sulfolane + 10% | 0.76 | 1.03 | 2.18 | 2.36 |
| furan + 10% DMS | | | | |
| 50% Sulfolane + 35% | 0.76 | 1.03 | 2.12 | 2.3 |
| DES + 15% DMS | | | | |
| 80% Sulfolane + 15% | 0.77 | 1.04 | 2.12 | 2.31 |
| DES + 5% DMS | | | | |
| 50% Sulfolane + 30% | 0.82 | 1.1 | 2.15 | 2.34 |
| NFM + 20% DMS | | | | |
| 80% Sulfolane + 10% | 0.78 | 1.05 | 2.17 | 2.37 |
| NFM + 10% DMS | | | | |

TABLE 6

| | BZ:OCT | BZ:OCT | BZ:OCT | BZ:OCT |
|---|---|---|---|---|
| Solvent (AT 125 C.) | (30:70) | (50:50) | (70:30) | (90:10) |
| Sulfolane | 0.77 | 1.04 | 2.14 | 2.33 |
| 50% Sulfolane + 10% | 0.80 | 1.07 | 2.20 | 2.41 |
| DVL + 40% DFP | | | | |
| 80% Sulfolane + 3% | 0.77 | 1.04 | 2.18 | 2.38 |
| DVL + 17% DFP | | | | |
| 50% Sulfolane + 15% | 0.82 | 1.10 | 2.19 | 2.40 |
| TMSO + 35% DFP | | | | |
| 80% Sulfolane + 3% | 0.77 | 1.04 | 2.19 | 2.39 |
| TMSO + 17% DFP | | | | |
| 50% Sulfolane + 15% | 0.77 | 1.04 | 2.18 | 2.38 |
| furan + 35% DFP | | | | |
| 80% Sulfolane + 5% | 0.76 | 1.02 | 2.19 | 2.39 |
| furan + 17% DFP | | | | |
| 50% Sulfolane + 15% | 0.81 | 1.1 | 2.18 | 2.38 |
| GBL + 35% DFP | | | | |
| 80% Sulfolane + 3% | 0.77 | 1.04 | 2.19 | 2.39 |
| GBL + 17% DFP | | | | |
| 50% Sulfolane + 15% | 0.76 | 1.03 | 2.17 | 2.37 |
| 3-MS + 35% DFP | | | | |
| 80% Sulfolane + 5% | 0.76 | 1.02 | 2.18 | 2.38 |
| 3-MS + 15% DFP | | | | |
| 50% Sulfolane + 10% | 0.83 | 1.12 | 2.13 | 2.33 |
| NMP + 40% DFP | | | | |
| 80% Sulfolane + 3% | 0.78 | 1.06 | 2.16 | 2.35 |
| NMP + 17% DFP | | | | |

TABLE 7

| | BZ:OCT | BZ:OCT | BZ:OCT | BZ:OCT |
|---|---|---|---|---|
| Solvent (AT 125 C.) | (30:70) | (50:50) | (70:30) | (90:10) |
| Sulfolane | 0.77 | 1.04 | 2.14 | 2.33 |
| 50% Sulfolane + 10% | 0.79 | 1.06 | 2.17 | 2.35 |
| TMSO + 40% EMS | | | | |
| 80% Sulfolane + 3% | 0.77 | 1.04 | 2.16 | 2.35 |
| TMSO + 17% EMS | | | | |
| 50% Sulfolane + 10% | 0.80 | 1.08 | 2.13 | 2.31 |
| DVL + 40% EMS | | | | |
| 80% Sulfolane + 3% | 0.78 | 1.04 | 2.15 | 2.34 |
| DVL + 17% EMS | | | | |
| 50% Sulfolane + 15% | 0.77 | 1.03 | 2.11 | 2.29 |
| 3-MS + 35% EMS | | | | |
| 80% Sulfolane + 3% | 0.76 | 1.02 | 2.16 | 2.34 |
| 3-MS + 17% EMS | | | | |
| 50% Sulfolane + 10% | 0.78 | 1.06 | 2.16 | 2.34 |
| GBL + 40% EMS | | | | |
| 80% Sulfolane + 3% | 0.77 | 1.04 | 2.16 | 2.34 |
| GBL + 17% EMS | | | | |
| 50% Sulfolane + 10% | 0.77 | 1.03 | 2.16 | 2.35 |
| NFM + 40% EMS | | | | |
| 80% Sulfolane + 3% | 0.76 | 1.03 | 2.16 | 2.35 |
| NFM + 17% EMS | | | | |
| 50% Sulfolane + 15% | 0.77 | 1.04 | 2.13 | 2.3 |
| furan + 35% EMS | | | | |
| 80% Sulfolane + 3% | 0.76 | 1.03 | 2.16 | 2.34 |
| furan + 17% EMS | | | | |

These tables provide examples of several systems with comparable or improved RV over sulfolane. However, other weight % of sulfolane can be used with similar ratios of first and second co-solvents; however, this may not result in an increase in RV.

### Example 2

In this experimental study, all chemicals utilized were sourced from Sigma Aldrich in India. The verification of solvent performance was conducted using Agilent HS-GC 7890A, incorporating a G1888 Headspace sampler. To maintain uniformity across all trials, a consistent sample weight was meticulously allocated to Agilent bottles. The constant sample amount on weight basis was taken in the Agilent bottle for all the experiments. After achieving sufficient equilibration time, the peak area of each component was noted from GC and mass concentration estimated with the proper response factor. While estimating relative volatility, the equilibrium liquid composition was assumed to be the same as the feed composition.

The mixture of TMSO and DMSO solvents were equilibrated with the liquid hydrocarbon feed containing benzene and octane at 85° C. and solvent-to-feed ratio of 3.

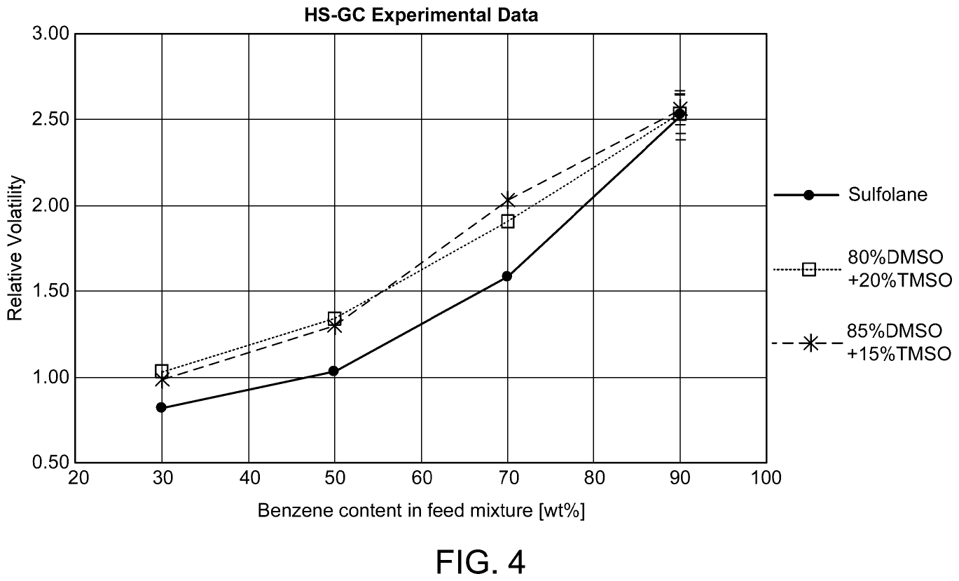

FIG. 4 shows the relative volatility across diverse feed compositions of a binary feed system of benzene and octane, with the X-coordinate representing the Benzene content within the feed mixture. Three solvents were studied in this example: 100% Sulfolane, 80% DMSO-20% TMSO mixture and 85% DMSO-15% TMSO mixture.

Examining the findings presented from the experiments, it is evident that the combined DMSO/TMSO solvent mixtures outperform the Sulfolane solvent in terms of relative volatility, across all benzene/octane ratios, in agreement with conclusions from COSMO-RS modeling.

### Specific Embodiments

While the following is described in conjunction with specific embodiments, it will be understood that this description is intended to illustrate and not limit the scope of the preceding description and the appended claims.

A first embodiment of the invention is a solvent mixture for extractive distillation of an aromatics-containing hydrocarbon feed stream consisting essentially of a first solvent having a higher octane-to-benzene relative volatility than sulfolane in a 90% benzene 10% octane feed mixture at 150° C. and 24:1 solvent-to-feed weight ratio per COSMOTherm modeling; a second solvent having a higher octane-to-benzene relative volatility than sulfolane in a 50% benzene 50% octane feed mixture at 150° C. and 3:1 solvent-to-feed weight ratio per COSMOTherm modeling; and optionally an additive; wherein the solvent mixture has a higher octane-to-benzene relative volatility than Sulfolane in a combined benzene and octane feed at 125° C. and 3:1 solvent-to-feed weight ratio per COSMOTherm modeling wherein a benzene weight ratio is higher than 30%. An embodiment of the invention is one, any or all of prior embodiments in this paragraph up through the first embodiment in this paragraph wherein the first solvent is present in an amount of 25% to 95% and the second solvent is present in an amount of 5% to 75%. An embodiment of the invention is one, any or all of prior embodiments in this paragraph up through the first embodiment in this paragraph wherein the first solvent is selected from the group consisting of dimethylsulfoxide (DMSO), 1,4-diformyl piperazine (DFP), dimethyl sulfone (DMS), ethyl-methyl sulfone (EMS), or combinations thereof. An embodiment of the invention is one, any or all of prior embodiments in this paragraph up through the first embodiment in this paragraph wherein the second solvent is selected from the group consisting of tetramethylene sulfoxide (TMSO), gamma butyrolactone (GBL), 2-furanone (furan), N-formyl morpholine (NFM), delta valerolactone (DVL), N-methyl-pyrrolidone (NMP), propylene carbonate, diethyl sulfone (DES), 3-methyl sulfolane (3-MS), or combinations thereof. An embodiment of the invention is one, any or all of prior embodiments in this paragraph up through the first embodiment in this paragraph wherein the additive is selected from the group consisting of a solutizer, an anti-foaming agent, an anti-corrosion agent, a stabilizer, a surfactant, a free-radical inhibitor, or combinations thereof. An embodiment of the invention is one, any or all of prior embodiments in this paragraph up through the first embodiment in this paragraph wherein the first solvent and the second solvent are present in the amounts specified in Table 1.

TABLE 1

| Solvent Systems | | | |
|---|---|---|---|
| First Solvent | Second Solvent | % Second Solvent | % First solvent |
| DMSO | TMSO | 10-60 | 40-90 |
| DMS | TMSO | 55-70 | 30-45 |
| DFP | TMSO | 25-50 | 50-75 |
| EMS | TMSO | 15-50 | 50-85 |
| DMSO | GBL | 15-75 | 25-85 |
| DMS | GBL | 45-65 | 35-55 |
| DFP | GBL | 25-40 | 60-75 |
| EMS | GBL | 10-30 | 70-90 |
| DMSO | Furanone | 10-50 | 50-90 |
| DMS | Furanone | 50-70 | 30-50 |
| DFP | Furanone | 25-50 | 50-75 |
| DMSO | DES | 25-75 | 25-75 |
| DMS | DES | 50-70 | 30-50 |
| DMSO | DVL | 10-50 | 50-90 |
| EMS | DVL | 10-25 | 75-90 |
| DFP | DVL | 20-50 | 50-80 |
| DMS | DVL | 35-75 | 25-65 |
| DMSO | NFM | 15-75 | 25-85 |
| EMS | NFM | 20-50 | 50-80 |
| DMSO | 3-MS | 20-50 | 50-80 |
| DMSO | NMP | 5-40 | 60-95 |
| DMS | NMP | 30-50 | 50-70 |
| DFP | NMP | 10-25 | 75-90 |
| EMS | NMP | 10-25 | 75-90 |

A second embodiment of the invention is a solvent mixture for extractive distillation of an aromatics-containing stream consisting essentially of a base solvent selected from the group consisting of sulfolane, N-methyl-pyrrolidone (NMP), N-formylmorpholine (NFM), dimethylformamide (DMF), a glycol derivative, or combinations there; a first co-solvent having a higher octane-to-benzene relative volatility than sulfolane in a 90% benzene 10% octane feed mixture at 150° C. and 24:1 solvent-to-feed weight ratio per COSMOTherm simulations; a second co-solvent having a higher octane-to-benzene relative volatility than sulfolane in a 50% benzene 50% octane feed mixture at 150° C. and 3:1 solvent-to-feed weight ratio per COSMOTherm simulations; optionally an additive; wherein the solvent mixture has a higher octane-to-benzene relative volatility than the base solvent in a combined benzene and octane feed at 125° C. and 3:1 solvent-to-feed weight ratio per COSMOTherm simulations where a benzene weight ratio is higher than 30%. An embodiment of the invention is one, any or all of prior embodiments in this paragraph up through the second embodiment in this paragraph wherein the weight ratio of the second co-solvent to the first co-solvent is in a range of 0.05:1 to 5:1 depending on the constituents, with the balance being the base solvent. An embodiment of the invention is one, any or all of prior embodiments in this paragraph up through the second embodiment in this paragraph wherein the first co-solvent is selected from the groups consisting of dimethylsulfoxide (DMSO), 1,4-diformyl piperazine (DFP), dimethyl sulfone (DMS), ethyl-methyl sulfone (EMS), or combinations thereof. An embodiment of the invention is one, any or all of prior embodiments in this paragraph up through the second embodiment in this paragraph wherein the second co-solvent is selected from the group consisting of tetramethylene sulfoxide (TMSO), gamma butyrolactone (GBL), 2-furanone (furan), N-formyl morpholine (NFM), delta valerolactone (DVL), N-methyl-pyrrolidone (NMP), propylene carbonate, diethyl sulfone (DES), 3-methyl sulfolane (3-MS), or combinations thereof. An embodiment of the invention is one, any or all of prior embodiments in this paragraph up through the second embodiment in this paragraph wherein the additive is selected from the group consisting of a solutizer, an anti-forming agent, an anti-corrosion agent, a stabilizer, a surfactant, a free-radical inhibitor, or combinations there. An embodiment of the invention is one, any or all of prior embodiments in this paragraph up through the second embodiment in this paragraph wherein the first and second co-solvents are present in the amounts specified in Table 2.

TABLE 2

| System Co-solvents | | |
|---|---|---|
| (Balance Sulfolane) | | |
| First | Second | Second Co-solvent to First |
| Co-solvent | Co-solvent | Co-solvent Weight Ratio |
| DMSO | TMSO | 0.1:1-2:1 |
| DMS | -TMSO | 1:1-3:1 |
| DFP | -TMSO | 0.1:1-1.5:1 |
| EMS | -TMSO | 0.1:1-1.5:1 |
| DMSO | GBL | 0.1:1-5:1 |
| DMS | GBL | 0.5:1-2.5:1 |
| DFP | GBL | 0.1:1-1:1 |
| EMS | GBL | 0.1:1-1:1 |
| DMSO | Furanone | 0.1:1-2:1 |
| DMS | Furanone | 0.5:1-2.5:1 |
| DFP | Furanone | 0.1:1-1.5:1 |
| DMSO | DES | 0.1:1-5:1 |
| DMS | DES | 0.5:1-3:1 |
| DMSO | DVL | 0.1:1-1.5:1 |
| EMS | DVL | 0.1:1-1:1 |
| DFP | DVL | 0.1:1-1.5:1 |
| DMS | DVL | 0.1:1-5:1 |
| DMSO | NFM | 0.1:1-5:1 |
| EMS | NFM | 0.1:1-1.5:1 |
| DMSO | 3-MS | 0.1:1-1.5:1 |
| DMSO | NMP | 0.05:1-1:1 |
| DMS | NMP | 0.1:1-1.5:1 |
| DFP | NMP | 0.1:1-1:1 |
| EMS | NMP | 0.1:1-1:1 |

A third embodiment of the invention is a method of aromatics extraction comprising introducing an aromatics-containing feed stream to an extractive distillation column at a feed stage; introducing a solvent mixture to the extractive distillation column at a stage above the feed stage, the solvent mixture consisting essentially of a first solvent having a higher octane-to-benzene relative volatility than sulfolane in a 90% benzene 10% octane feed mixture at 150° C. and 24:1 solvent-to-feed weight ratio per COSMOTherm simulations; a second solvent having higher octane-to-benzene relative volatility than sulfolane in a 50% benzene 50% octane feed mixture at 150° C. and 3:1 solvent-to-feed weight ratio per COSMOTherm simulations; and optionally an additive recovering a bottoms stream comprising an aromatics-rich stream; and recovering an overhead stream comprising an aromatics-lean stream. An embodiment of the invention is one, any or all of prior embodiments in this paragraph up through the third embodiment in this paragraph wherein the first solvent is present in an amount of 25% to 95% and the second solvent is present in an amount of 5% to 75%. An embodiment of the invention is one, any or all of prior embodiments in this paragraph up through the third embodiment in this paragraph wherein the first solvent is selected from the group consisting of dimethylsulfoxide (DMSO), 1,4-diformyl piperazine (DFP), dimethyl sulfone (DMS), ethyl-methyl sulfone (EMS), or combinations thereof; or wherein the second solvent is selected from the group consisting of tetramethylene sulfoxide (TMSO), gamma butyrolactone (GBL), 2-furanone, N-formyl morpholine (NFM), delta valerolactone (DVL), N-methyl-pyrrolidone (NMP), propylene carbonate, diethyl sulfone (DES), 3-methyl sulfolane (3-MS), or combinations thereof; or both. An embodiment of the invention is one, any or all of prior embodiments in this paragraph up through the third embodiment in this paragraph wherein the additive is selected from the group consisting of a solutizer, an anti-forming agent, an anti-corrosion agent, a stabilizer, a surfactant, a free-radical inhibitor, or combinations thereof.

A fourth embodiment of the invention is a method of aromatics extraction comprising introducing an aromatics-containing feed stream to an extractive distillation column at a feed stage; introducing a solvent mixture to the extractive distillation column at a stage above the feed stage, the solvent mixture consisting essentially of a base solvent selected from the group consisting of sulfolane, N-methyl-pyrrolidone (NMP), N-formylmorpholine (NFM), dimethylformamide (DMF), glycol, glycol derivatives, or combinations thereof; a first co-solvents having a higher octane-to-benzene relative volatility than sulfolane in a 90% benzene 10% octane feed mixture at 150° C. and 24:1 solvent-to-feed weight ratio per COSMOTherm simulations, a second co-solvent a having higher octane-to-benzene relative volatility than sulfolane in a 50% benzene 50% octane feed mixture at 150° C. and 3:1 solvent-to-feed weight ratio per COSMOTherm simulations; and optionally an additive; recovering a bottoms stream comprising an aromatics-rich stream; and recovering an overhead stream comprising an aromatics-lean stream. An embodiment of the invention is one, any or all of prior embodiments in this paragraph up through the fourth embodiment in this paragraph wherein a weight ratio of the second co-solvent to the first co-solvent is in a range of 0.05:1 to 5:1 with the balance being the base solvent. An embodiment of the invention is one, any or all of prior embodiments in this paragraph up through the fourth embodiment in this paragraph wherein the first co-solvent is selected from the groups consisting of dimethylsulfoxide (DMSO), 1,4-diformyl piperazine (DFP), dimethyl sulfone (DMS), ethyl-methyl sulfone (EMS), or combinations thereof; or wherein the second co-solvent is selected from the group consisting of tetramethylene sulfoxide (TMSO), gamma butyrolactone (GBL), 2-furanone (furan), N-formyl morpholine (NFM), delta valerolactone (DVL), N-methyl-pyrrolidone (NMP), propylene carbonate, diethyl sulfone (DES), 3-methyl sulfolane (3-MS), or combinations thereof; or both. An embodiment of the invention is one, any or all of prior embodiments in this paragraph up through the fourth embodiment in this paragraph wherein the additive is selected from the group consisting of a solutizer, an anti-forming agent, or an anti-corrosion agent, a stabilizer, a surfactant, a free-radical inhibitor, or combinations thereof.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A solvent mixture for extractive distillation of an aromatics-containing hydrocarbon feed stream consisting essentially of:
a first solvent having a higher octane-to-benzene relative volatility than sulfolane in a 90% benzene 10% octane feed mixture at 150° C. and 24:1 solvent-to-feed weight ratio;
a second solvent having a higher octane-to-benzene relative volatility than sulfolane in a 50% benzene 50% octane feed mixture at 150° C. and 3:1 solvent-to-feed weight ratio; and
optionally an additive;
wherein the solvent mixture has a higher octane-to-benzene relative volatility than Sulfolane in a combined benzene and octane feed at 125° C. and 3:1 solvent-to-feed weight ratio wherein a benzene weight ratio is higher than 30%.

2. The solvent mixture of claim 1 wherein the first solvent is present in an amount of 25% to 95% and the second solvent is present in an amount of 5% to 75%.

3. The solvent mixture of claim 1 wherein the first solvent is selected from the group consisting of dimethylsulfoxide (DMSO), 1,4-diformyl piperazine (DFP), dimethyl sulfone (DMS), ethyl-methyl sulfone (EMS), or combinations thereof.

4. The solvent mixture of claim 1 wherein the second solvent is selected from the group consisting of tetramethylene sulfoxide (TMSO), gamma butyrolactone (GBL), 2-furanone, N-formyl morpholine (NFM), delta valerolactone (DVL), N-methyl-pyrrolidone (NMP), propylene carbonate, diethyl sulfone (DES), 3-methyl sulfolane (3-MS), or combinations thereof.

5. The solvent mixture of claim 1 wherein the additive is selected from the group consisting of a solutizer, an anti-foaming agent, an anti-corrosion agent, a stabilizer, a surfactant, a free-radical inhibitor, or combinations thereof.

6. The solvent mixture of claim 1 wherein the first solvent and the second solvent are present in the amounts specified in Table 1:
TABLE 1

| Solvent Systems | | | |
|---|---|---|---|
| First Solvent | Second Solvent | % Second Solvent | % First solvent |
| DMSO | TMSO | 10-60 | 40-90 |
| DMS | TMSO | 55-70 | 30-45 |
| DFP | TMSO | 25-50 | 50-75 |
| EMS | TMSO | 15-50 | 50-85 |
| DMSO | GBL | 15-75 | 25-85 |
| DMS | GBL | 45-65 | 35-55 |
| DFP | GBL | 25-40 | 60-75 |
| EMS | GBL | 10-30 | 70-90 |
| DMSO | Furanone | 10-50 | 50-90 |
| DMS | Furanone | 50-70 | 30-50 |
| DFP | Furanone | 25-50 | 50-75 |
| DMSO | DES | 25-75 | 25-75 |
| DMS | DES | 50-70 | 30-50 |
| DMSO | DVL | 10-50 | 50-90 |
| EMS | DVL | 10-25 | 75-90 |
| DFP | DVL | 20-50 | 50-80 |
| DMS | DVL | 35-75 | 25-65 |
| DMSO | NFM | 15-75 | 25-85 |
| EMS | NFM | 20-50 | 50-80 |
| DMSO | 3-MS | 20-50 | 50-80 |
| DMSO | NMP | 5-40 | 60-95 |
| DMS | NMP | 30-50 | 50-70 |
| DFP | NMP | 10-25 | 75-90 |
| EMS | NMP | 10-25 | 75-90 |

7. A solvent mixture for extractive distillation of an aromatics-containing stream consisting essentially of:
a base solvent selected from the group consisting of sulfolane, N-methyl-pyrrolidone (NMP), N-formylmorpholine (NFM), dimethylformamide (DMF), a glycol derivative, or combinations there;
a first co-solvent having a higher octane-to-benzene relative volatility than sulfolane in a 90% benzene 10% octane feed mixture at 150° C. and 24:1 solvent-to-feed weight ratio;
a second co-solvent having a higher octane-to-benzene relative volatility than sulfolane in a 50% benzene 50% octane feed mixture at 150° C. and 3:1 solvent-to-feed weight ratio;
optionally an additive;
wherein the solvent mixture has a higher octane-to-benzene relative volatility than the base solvent in a combined benzene and octane feed at 125° C. and 3:1 solvent-to-feed weight ratio where a benzene weight ratio is higher than 30%.

8. The solvent mixture of claim 7 wherein a weight ratio of the second co-solvent to the first co-solvent is in a range of 0.05:1 to 5:1 with the balance being the base solvent.

9. The solvent mixture of claim 7 wherein the first co-solvent is selected from the groups consisting of dimethylsulfoxide (DMSO), 1,4-diformyl piperazine (DFP), dimethyl sulfone (DMS), ethyl-methyl sulfone (EMS), or combinations thereof.

10. The solvent mixture of claim 7 wherein the second co-solvent is selected from the group consisting of tetramethylene sulfoxide (TMSO), gamma butyrolactone (GBL), 2-furanone (furan), N-formyl morpholine (NFM), delta valerolactone (DVL), N-methyl-pyrrolidone (NMP), propylene carbonate, diethyl sulfone (DES), 3-methyl sulfolane (3-MS), or combinations thereof.

11. The solvent mixture of claim 7 wherein the additive is selected from the group consisting of a solutizer, an anti-forming agent, an anti-corrosion agent, a stabilizer, a surfactant, a free-radical inhibitor, or combinations there.

12. The solvent mixture of claim 7 wherein the first and second co-solvents are present in the amounts specified in Table 2.
TABLE 2

| System Co-solvents | | |
|---|---|---|
| (Balance Sulfolane) | | |
| First | Second | Second Co-solvent to First |
| Co-solvent | Co-solvent | Co-solvent Weight Ratio |
| DMSO | TMSO | 0.1:1-2:1 |
| DMS | -TMSO | 1:1-3:1 |
| DFP | -TMSO | 0.1:1-1.5:1 |
| EMS | -TMSO | 0.1:1-1.5:1 |
| DMSO | GBL | 0.1:1-5:1 |
| DMS | GBL | 0.5:1-2.5:1 |
| DFP | GBL | 0.1:1-1:1 |
| EMS | GBL | 0.1:1-1:1 |
| DMSO | Furanone | 0.1:1-2:1 |
| DMS | Furanone | 0.5:1-2.5:1 |
| DFP | Furanone | 0.1:1-1.5:1 |
| DMSO | DES | 0.1:1-5:1 |
| DMS | DES | 0.5:1-3:1 |
| DMSO | DVL | 0.1:1-1.5:1 |
| EMS | DVL | 0.1:1-1:1 |
| DFP | DVL | 0.1:1-1.5:1 |
| DMS | DVL | 0.1:1-5:1 |
| DMSO | NFM | 0.1:1-5:1 |
| EMS | NFM | 0.1:1-1.5:1 |
| DMSO | 3-MS | 0.1:1-1.5:1 |
| DMSO | NMP | 0.05:1-1:1 |
| DMS | NMP | 0.1:1-1.5:1 |
| DFP | NMP | 0.1:1-1:1 |
| EMS | NMP | 0.1:1-1:1 |

13. A method of aromatics extraction comprising:
introducing an aromatics-containing feed stream to an extractive distillation column at a feed stage;
introducing a solvent mixture to the extractive distillation column at a stage above the feed stage, the solvent mixture consisting essentially of:
a first solvent having a higher octane-to-benzene relative volatility than sulfolane in a 90% benzene 10% octane feed mixture at 150° C. and 24:1 solvent-to-feed weight ratio;
a second solvent having higher octane-to-benzene relative volatility than sulfolane in a 50% benzene 50% octane feed mixture at 150° C. and 3:1 solvent-to-feed weight ratio; and
optionally an additive:
recovering a bottoms stream comprising an aromatics-rich stream; and
recovering an overhead stream comprising an aromatics-lean stream.

14. The method of claim 13 wherein the first solvent is present in an amount of 25% to 95% and the second solvent is present in an amount of 5% to 75%.

15. The method of claim 13:
wherein the first solvent is selected from the group consisting of dimethylsulfoxide (DMSO), 1,4-diformyl piperazine (DFP), dimethyl sulfone (DMS), ethyl-methyl sulfone (EMS), or combinations thereof; or
wherein the second solvent is selected from the group consisting of tetramethylene sulfoxide (TMSO), gamma butyrolactone (GBL), 2-furanone (furan), N-formyl morpholine (NFM), delta valerolactone (DVL), N-methyl-pyrrolidone (NMP), propylene carbonate, diethyl sulfone (DES), 3-methyl sulfolane (3-MS), or combinations thereof; or
both.

16. The method of claim 13 wherein the additive is selected from the group consisting of a solutizer, an anti-forming agent, an anti-corrosion agent, a stabilizer, a surfactant, a free-radical inhibitor, or combinations thereof.

17-20. (canceled)
